(19) United States
(12) Patent Application Publication
(10) Pub. No.: US 2013/0002558 A1
(43) Pub. Date: Jan. 3, 2013

(54) INPUT METHOD AND INPUT DEVICE

(75) Inventors: Sai Hung HO, Hong Kong (CN); Jack LAU, Hong Kong (CN); Kam Yiu Donald CHAN, Hong Kong (CN)

(73) Assignee: Perception Digital Limited, Hong Kong (CN)

(21) Appl. No.: 13/345,921

(22) Filed: Jan. 9, 2012

(30) Foreign Application Priority Data
Jun. 28, 2011 (CN) 201110177492.8

(51) Int. Cl. G06F 3/02

(52) U.S. Cl. 345/168

(57) ABSTRACT

The present disclosure generally relates to an input method including the steps of: receiving a key event sequence inputted by a keyboard; comparing the key event sequence with prestored data, determining whether the key event sequence is a sequence predefined by the prestored data; if the key event sequence is determined to be the sequence predefined by the prestored data, finding an input command corresponding with the key event sequence according to a mapping relationship and sending the input command to a command processing system. By using the input method, a keyboard using feature value of the key event sequence to map to a corresponding input command, which makes the condition of the keyboard determines whether an input command is triggered no longer depending on the physical location of one key strictly.

### FIELD OF THE INVENTION

The present disclosure generally relates to human-computer interaction technologies, and more particularly to an input method.

### BACKGROUND OF THE INVENTION

Keyboard is a type of conventional input devices, and it is used in most devices including computers, mobile phones, and PDAs for human-computer interaction via inputting command. The keyboard can act as a remote controller of a set-top box. A conventional keyboard includes a shell, a PCB (Printed Circuit Board), and some keys. According to the conventional input method, when a key is pressed or bounced, the key sends a signal to the PCB disposed between the key and a base of the keyboard. A logic circuit on the PCB generates an electric signal according to the physical location of the key on the keyboard, the electric signal is sent to an input processing system. The input processing system transforms the electric signal to corresponding input command and sends the input command to a command processing system.

In the conventional input method, whether an input event is occurred is determined by detecting whether one key on the keyboard is pressed. If a key is pressed once, the pressing is sent to an input control system as an input event, and then the input control system maps the input event to an input command and sends it to a command processing system. A plurality of pressing will generate a plurality of pressing events, and there is a one-to-one correspondence between the pressing event and the input command.

The conventional input method of the keyboard mentioned above is well used in conventional input control applications. But the conventional input method of the keyboard requires a high demand of pressing precision on the keyboard for the user. When the conventional input method of the keyboard is used in some special applications, such as an application has complex input control, the usage of conventional input method of the keyboard is limited. As an example, a set-top box which can connect the internet is not only a receiver of a TV set, but also a host which can access the network, so the set-top box has many functions such as accessing web pages, watching internet videos and so on. However, the input control using the keypad of a remote controller is complex. We can take a common keyboard and mouse as a remote controller when using the set-top box. Because the user is far from a TV screen, and the control of the keyboard is complex, it's hard to find corresponding keys during remote control process and easy to make mistake, which leads to bad experience to the user.

### SUMMARY

In order to solve the problem that conventional input method of the keyboard is inconvenient in operation, the present disclosure provides an input method which can reduce misoperation rate.

An input method including the steps of: receiving a key event sequence inputted by a keyboard; comparing the key event sequence with prestored data, determining whether the key event sequence is a sequence predefined by the prestored data; if the key event sequence is determined to be the sequence predefined by the prestored data, finding an input command corresponding with the key event sequence according to a mapping relationship and sending the input command to a command processing system.

In an embodiment, the step of comparing the key event sequence with prestored data, determining whether the key event sequence is a sequence predefined by the prestored data includes: calculating a feature value of the key event sequence, the feature value is a feature information to represent a corresponding location of a single key event in the key event sequence; comparing the feature value with a preset standard feature value set, if the feature value is in the preset standard feature value set, determining the key event sequence as the sequence predefined by the prestored data, otherwise ending current input process. In an embodiment, the predefined sequence represents adjacent keys are pressed continuously.

In an embodiment, the predefined sequence represents adjacent keys are pressed continuously to form a preset vector graphic.

In an embodiment, the preset vector graphic can be at least one of a horizontal straight line, a vertical straight line, a hook shape, a crisscross, a circular shape, or a character shape.

In an embodiment, the predefined sequence represents at least two adjacent keys on a region of the keyboard being pressed at the same time or one key being pressed continuously.

The present disclosure further provides an input device includes: a receiver module used for receiving a key event sequence inputted by a keyboard; a memory module used for prestoring a data representing a predefined sequence; a control module used for comparing the key event sequence with the prestored data, determining whether the key event sequence is a sequence predefined by the prestored data, if the key event sequence is determined to be a sequence predefined by the prestored data, finding an input command corresponding with the key event sequence according to a mapping relationship and sending the input command to a command processing system.

In an embodiment, the control module includes: a calculation unit used for calculating a feature value of the key event sequence, the feature value is feature information to represent a corresponding location of a single key event in the key event sequence; a compare unit used for comparing the feature value with a preset standard feature value set, if the feature value is in the preset standard feature value set, determining the key event sequence as the sequence predefined by the prestored data, otherwise ending of the current input process.

In an embodiment, the predefined sequence represents adjacent keys are pressed continuously.

In an embodiment, the predefined sequence represents adjacent keys are pressed continuously to form a preset vector graphic.

In an embodiment, the preset vector graphic can be at least one of a horizontal straight line, a vertical straight line, a hook shape, a crisscross, a circular shape, or a character shape.

In an embodiment, the predefined sequence represents at least two adjacent keys on a region of the keyboard being pressed at the same time or one key being pressed continuously.

The input method and input device mentioned above determine whether a key event sequence is the sequence predefined by the prestored data by receiving the key event sequence. If the determined result is yes, the input command mapping to the key event sequence should be found and sent to a command processing system. It makes the condition of a keyboard determines whether an input command is triggered no longer depending on the physical location of one key strictly, but only need conforming to rules required by predefined sequences. So the convenience of operation is enhanced.

### BRIEF DESCRIPTION OF THE DRAWINGS

FIG. 1 is a flowchart illustrating an embodiment of an input method;

FIG. 2 is a flowchart illustrating another embodiment of the input method;

FIG. 3 is a schematic diagram illustrating an embodiment of a keyboard;

FIG. 4 is a schematic diagram illustrating an embodiment of an input device;

FIG. 5 is a schematic diagram of a control module in FIG. 4.

### DETAILED DESCRIPTION

The detailed description of the present disclosure will be discussed in the following embodiments, which are not intended to limit the scope of the present disclosure, but still can be adapted for other applications. While drawings are illustrated in details, it is appreciated that the quantity of the disclosed components could be greater or less than that disclosed, except those components with expressly restricting amount.

In a conventional input method of a keyboard, the key information is mapped to input commands, such key information is a single key event. The single key event is defined as pressing a key of the keyboard once. If the key is pressed once, the single key event is triggered, and then an input processing system maps the single key event to an input command and sends the single key event to a command processing system.

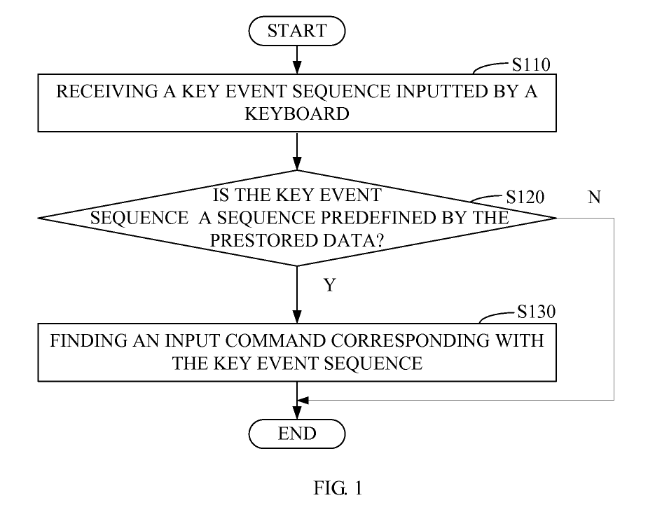

In an embodiment of an input method shown in FIG. 1, the input method includes following steps:

S110, receive a key event sequence inputted by a keyboard. In the following embodiment of the input method, the key event sequence is mapped to the input command. The definition of the key event sequence to is: a sequence starting from a received single key event and ending with the last received single key event which is defined by a preset rule, and all event elements of the sequence are arranged according to the sequence of pressing in chronological order.

S120, compare the key event sequence with prestored data, determine whether the key event sequence is a sequence predefined by the prestored data. The sequence predefined by the prestored data can be a direct prestored sequence. For example, take keys of A, S, D, F, G which are pressed in sequence as the prestored sequence. When the key event sequence represents the keys are pressed in sequence as A, S, D, F, G, the key event sequence is determined as the sequence predefined by the prestored data. Besides, the prestored data can also be a prestored rule of the key event sequence. It means the received key event sequence could be processed, and then be determined whether it satisfied the rules stipulated by the prestored data. If the received key event sequence satisfies the rules, the key event sequence should be considered as the sequence predefined by the prestored data. An example with further explanation will be illustrated in the next embodiment of the input method.

S130, if the determined result of the step S120 is yes, an input command corresponding with the key event sequence according to a mapping relationship should be found and sent to a command processing system. For example, if a key event sequence of pressing keys of A, S, D, F, G in sequence is the sequence predefined by the prestored data, and an input command corresponding with the sequence predefined by the prestored data is “press keys sliding from left to right”, the input command will be sent to the command processing system. An audio player can process the command of “press keys sliding from left to right” as playing the next audio, which is equivalent to inputting a command of “next”. As another example, if a key event sequence of pressing keys of 1, 5, 9, and then 3, 5, 7 on a standard remote controller or a numeric keypad of a mobile phone in sequence is the sequence predefined by the prestored data, and an input command corresponding with the sequence predefined by the prestored is “take a sliding compression to form a X”, the input command will be sent to the command processing system. A web browser can process the command of “take a sliding compression to form a X” as to a command of closing the current window. Of course, for different command processing systems, the specific command can be adjusted if needed.

The input method mentioned above using feature value of the key event sequence to map to a corresponding input command, which makes the trigger condition of the input command no longer depending on the physical location of one key strictly. For example, to perform an input process by starting at pressing a key anywhere on a keyboard and sliding straight right by pressing at least one key, there is no need to consider how many and exactly which keys are pressed during sliding, it only needs to ensure the path of sliding on the keyboard by pressing key is a straight line from left to right, the currently inputted key information should be mapped to the corresponding input command. This input method can avoid misoperation caused by pressing a plurality of keys at the same time when the keys are relatively small and dense.

In a preferred embodiment, these predefined sequences represent adjacent keys are pressed continuously, which means an user use a finger, a palm, or other press tool to do a continuous sliding compression operation, such as pressing keys of A, S, D, F, G continuously on a standard computer keyboard, pressing keys of 1, 5, 9 continuously on a mobile phone keypad, or pressing keys of 4, 5, 6 continuously on a remote controller keypad. In this way, the corresponding input command can be simply generated by pressing key and sliding on the keyboard, which does not require complex operation or finding the exact key for the specific input command among all keys, so the operation will become simpler.

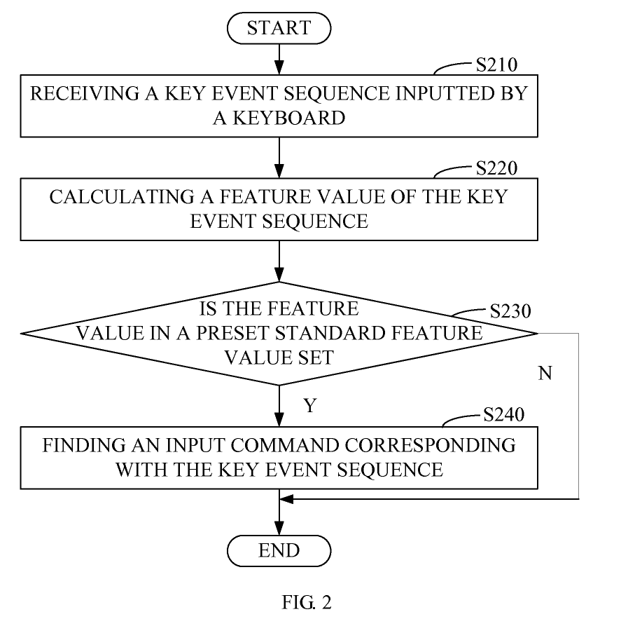

In another embodiment of the input method shown in FIG. 2, the input method includes following steps:

S210, receive a key event sequence inputted by a keyboard. In a preferred embodiment, the key event sequence is defined by the follow method: take a received single key event S as the beginning of the sequence, once another single key event is received, it will be added to the end of the sequence. Set a time period T for determination, if there is no single key event being received after a single key event E is added within time T, the single key event E should be taken as the end of the sequence.

S220, calculate the feature value of the key event sequence. The feature value is feature information to represent a corresponding location of a single key event in the key event sequence.

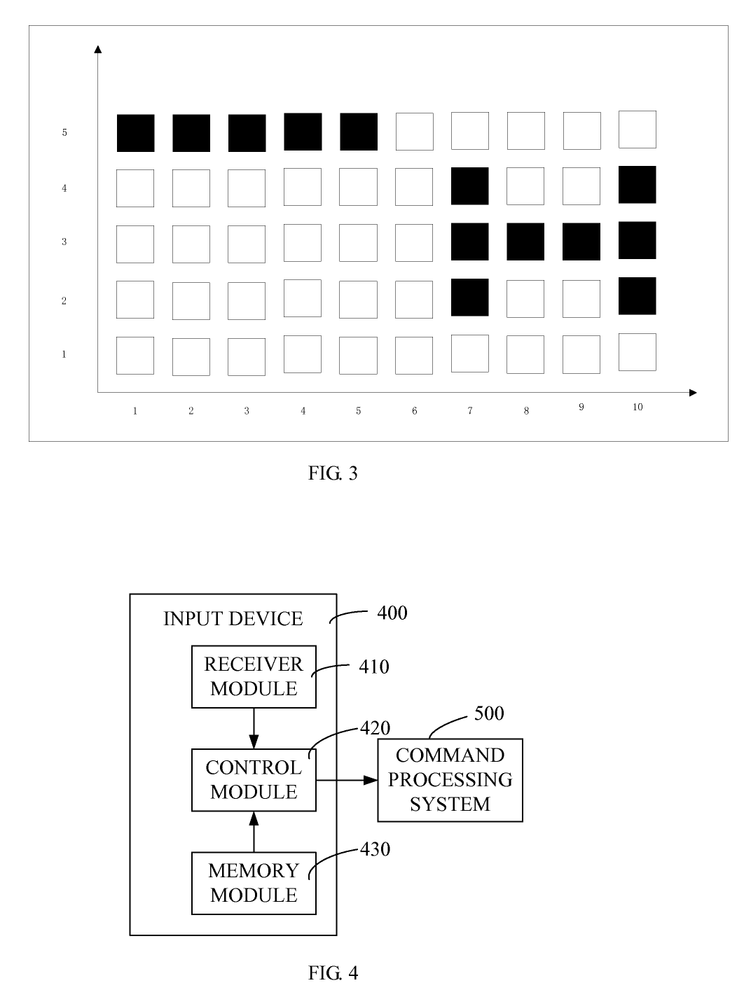

As shown in FIG. 3, to build a coordinate system, one side of the keyboard is regarded as ordinate and the bottom of the keyboard is regarded as abscissa. The key event sequence of the key event E is [e1, e2, e3, e4, e5]. And e1, e2, e3, e4, e5 are single key events. Their location information sequence is [l1, l2, l3, l4, l5], which is represent in the coordinate system as [(x1, y1), (x2, y2), (x3, y3), (x4, y4), (x5, y5)]. Their corresponding location information is [(0, 0), (x2−x1, y2−y1), (x3−x1, y3−y1), (x4−x1, y4−y1), (x5−x1, y5−y1)]. The location information sequence has a feature of: y1=y2=y3=y4=y5, x5>x4>x3>x2>x1. So the corresponding location information sequence changes to [(0, 0), (x2−x1, j), (x3−x1, 0), (x4−x1, 0), (x5−x1, 0)], which has a X value sequence as [(0), (x2−x1), (x3−x1), (x4−x1), (x5−x1)], and a Y value sequence as [0, 0, 0, 0, 0]. So the specific feature of this corresponding location information sequence is: the Y value sequence is all 0, and the X value sequence is incremental.

In a preferred embodiment, a method of representing the feature value of this sequence is: generate a decimal data of two digit places. Using the first digit place to represent whether the X value sequence of the corresponding location information sequence is incremental, the first digit place is 1 when the X value sequence is incremental; the first digit place is 2 when the X value sequence is descending; the first digit place is 3 when the X value sequence is neither incremental nor descending. Using the second digit place to represent whether the Y value sequence of the corresponding location information sequence is all 0, the second digit place is 1 if the Y value sequence is all 0; otherwise the second digit place is 2. In this embodiment, the X value sequence of a key event sequence A is [0, (ax2−ax1), (ax3−ax1), (ax4−ax1), (ax5−ax1)], and the Y value sequence is [0, (ay2−ay1), (ay3−ay1), (ay4−ay1), (ay5−ay1)], wherein ay1=ay2=ay3=ay4=ay5, ax1<ax2<ax3<ax4<ax5, so the feature value of this sequence A is 11. The X value sequence of a key event sequence B is [0, (bx2−bx1), (bx3−bx1), (bx4−bx1), (bx5−bx1)], and the Y value sequence is [0, (by2−by1), (by3−by1), (by4−by1), (by5−by1)], wherein bx1<bx2<bx3<bx4<bx5, by1>by2>by3>by >by5, so the feature value of this sequence B is 12.

S230, compare the feature value generated in step S220 with the preset standard feature value set, if the feature value is in the preset standard feature value set, the key event sequence is determined as the sequence predefined by the prestored data, otherwise the whole current input process is ended.

In a preferred embodiment, if the preset standard feature value set is [11, 21], and if the feature value of the key event sequence A is 11, then the feature value of the key event sequence A is in the preset standard feature value set [11, 21], so the step S240 will be continued. If the feature value of the key event sequence B is 12, then the feature value of the key event sequence B is not in the preset standard feature value set [11, 21], so the whole current input process is ended.

S240, find the input command corresponding with the feature information by the mapping relationship, and send the input command to the command processing system.

In a preferred embodiment, a name of the command corresponding with feature value 11 is forward, a name of the command corresponding with feature value 21 is back. So the key event sequence A will trigger the command forward, the key event sequence B will not trigger any command.

After using the input method mentioned above, the condition of determining whether the input command should be triggered changes from whether the single key event is triggered to whether the feature value of key event sequence is in the preset standard feature value set. Comparing with the conventional technology, the determining condition becomes more flexible, which no longer requires an accurate pressing location, and it only requires a similar type of operation which has the same feature value to trigger the command.

In an embodiment, the predefined sequence represents adjacent keys are pressed continuously to form a preset vector graphic. For example, the preset vector graphic can be at least one of a horizontal straight line, a vertical straight line, a hook shape, a crisscross, a circular shape, or a character shape. The preset vector graphic can be represented by the direct prestored sequence, or be reflected by the calculation rules mentioned above. Representing with the preset vector graphic is beneficial to understanding the operation. For example, a user only requires pressing adjacent keys on the keyboard to form a hook shape when he wants to input an “OK” command; and the user only requires pressing adjacent keys on the keyboard to form a crisscross when he wants to input a “cancel” command.

In an embodiment, the predefined sequence represents more than two adjacent keys on a region of the keyboard being pressed at the same time. By setting this type of predefined sequence, some preset functions can be enabled when a user presses more than two adjacent keys on a region of the keyboard at the same time. For example, the user can press a plurality of keys on the keyboard by his palm to achieve the function of closing the whole program.

In an embodiment, the predefined sequence represents one key is pressed continuously. By setting this type of predefined sequence, some preset functions can be enabled when a user presses one key continuously. For example, the user can press S key continuously to enable the searching function.

FIG. 4 is a schematic diagram of an input device 400. The input device 400 includes a receiver module 410, a control module 420 connected to the receiver module 410, and a memory module 430 connected to the control module 420.

The receiver module 410 is used for receiving a key event sequence inputted by a keyboard. In the following embodiment of the input device 400, there is not the single key event but the key event sequence mapping to the input command. The definition of the key event sequence is: a sequence starting from a received single key event and ending with the last received single key event which is defined by a preset rule, and all the event elements of the sequence are arranged in sequence of pressing in chronological order.

The memory module 430 is used for prestoring a data representing a predefined sequence. The sequence predefined by the prestored data can be a direct prestored sequence. For example, take keys of A, S, D, F, G which are pressed in sequence as the prestored sequence. When the key event sequence represents the keys are pressed in sequence as A, S, D, F, G, the key event sequence are determined as the sequence predefined by the prestored data. Besides, the prestored data can also be a prestored rule of the key event sequence. It means a received key event sequence could be processed, then be determined whether it satisfied the rules stipulated by the prestored data. If the received key event sequence satisfies the rules, the key event sequence should be considered as the sequence predefined by the prestored data. An example with further explanation will be illustrated in the next embodiment of the input device. The control module 420 is connected to the receiver module 410 and the memory module 430, and used for comparing the key event sequence with the prestored data, determining whether the key event sequence is a sequence predefined by the prestored data. If the determined result is yes, an input command corresponding with the key event sequence according to a mapping relationship should be found and sent to a command processing system 500. For example, if a key event sequence of pressing keys of A, S, D, F, G in sequence is the sequence predefined by the prestored data, and an input command corresponding with the sequence predefined by the prestored data is “press keys sliding from left to right”, the input command will be sent to the command processing system 500. An audio player can process the command of “press keys sliding from left to right” as to playing the next audio, which is equivalent to inputting a command of “next”. As another example, if a key event sequence of pressing keys of 1, 5, 9, and then 3, 5, 7 on a standard remote controller or a numeric keypad of a mobile phone in sequence is the sequence predefined by the prestored data, and an input command corresponding with the sequence predefined by the prestored is “take a sliding compression to form a X”, the input command will be sent to the command processing system 500. A web browser can process the command of “take a sliding compression to form a X” as to a command of closing the current window. Of course, for different command processing systems, the specific command can be adjusted if needed.

In a preferred embodiment, these predefined sequences represent adjacent keys are pressed continuously, which means an user use a finger, a palm, or other press tool to do a continuous sliding compression operation, such as pressing keys of A, S, D, F, G continuously on a standard computer keyboard, pressing keys of 1, 5, 9 continuously on a mobile phone keypad, or pressing keys of 4, 5, 6 continuously on a remote controller keypad. In this way, the corresponding input command can be simply generated by pressing key and sliding on the keyboard, which does not require complex operation or finding the exact key for the specific input command among all keys, so the operation will become simpler.

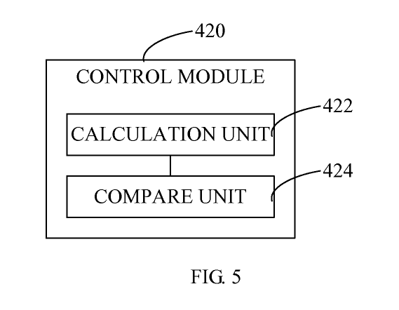

In an embodiment shown in FIG. 5, the control module 420 includes a calculation unit 422 and a compare unit 424 connected to the calculation unit 422.

The calculation unit 422 is used for calculating the feature value of the key event sequence. The feature value is feature information to represent a corresponding location of a single key event in the key event sequence.

As shown in FIG. 3, to build a coordinate system, one side of the keyboard is regarded as ordinate and the bottom of the keyboard is regarded as abscissa. The key event sequence of the key event E is [e1, e2, e3, e4, e5]. And e1, e2, e3, e4, e5 are single key events. Their location information sequence is [l1, l2, l3, l4, l5], which is represent in the coordinate system as [(x1, y1), (x2, y2), (x3, y3), (x4, y4), (x5, y5)]. Their corresponding location information is [(0, 0), (x2−x1, y2−y1), (x3−x1, y3−y1), (x4−x1, y4−y1), (x5−x1, y5−y1)]. The location information sequence has a feature of: y1=y2=y3=y4=y5, x5>x4>x3>x2>x1. So the corresponding location information sequence changes to [(0, 0), (x2−x1, 0), (x3−x1, 0), (x4−x1, 0), (x5−x1, 0)], which has a X value sequence as [(0), (x2−x1), (x3−x1), (x4−x1), (x5−x1)], and a Y value sequence as [0, 0, 0, 0, 0]. So the specific feature of this corresponding location information sequence is: the Y value sequence is all 0, and the X value sequence is incremental.

In an embodiment, a method of representing the feature value of this sequence is: generate a decimal data of two digit places. Using the first digit place to represent whether the X value sequence of the corresponding location information sequence is incremental, the first digit place is 1 when the X value sequence is incremental; the first digit place is 2 when the X value sequence is descending; the first digit place is 3 when the X value sequence is neither incremental nor descending. Using the second digit place to represent whether the Y value sequence of the corresponding location information sequence is all 0, the second digit place is 1 if the Y value sequence is all 0; otherwise the second digit place is 2. In this embodiment, the X value sequence of a key event sequence A is [0, (ax2−ax1), (ax3−ax1), (ax4−ax1), (ax5−ax1)], and the Y value sequence is [0, (ay2−ay1), (ay3−ay1), (ay4−ay1), (ay5−ay1)], wherein ay1=ay2=ay3=ay4=ay5, ax1<ax2<ax3<ax4<ax5, so the feature value of this sequence A is 11. The X value sequence of a key event sequence B is [0, (bx2−bx1), (bx3−bx1), (bx4−bx1), (bx5−bx1)], and the Y value sequence is [0, (by2−by1), (by3−by1), (by4−by1), (by5−by1)], wherein bx1<bx2<bx3<bx4<bx5, by1>by2>by3>by >by5, so the feature value of this sequence B is 12.

The compare unit 424 is used for comparing the feature value with the preset standard feature value set, if the feature value is in the preset standard feature value set, the key event sequence is determined as the sequence predefined by the prestored data, otherwise the compare unit 424 ends the current input process.

In an embodiment, if the predefined standard feature value set is [11, 21], and if the feature value of the key event sequence A is 11, then the feature value of the key event sequence A is in the preset standard feature value set [11, 21], so the key event sequence is determined as the sequence predefined by the prestored data. If the feature value of the key event sequence B is 12, then the feature value of the key event sequence B is not in the preset standard feature value set [11, 21], so the compare unit 424 ends the current input process.

In a preferred embodiment, sequences predefined by the input device 400 represent adjacent keys are pressed continuously, which means an user use a finger, a palm, and so on to do a continuous sliding compression operation, such as pressing keys of A, S, D, F, G continuously on a standard computer keyboard, pressing keys of 1, 5, 9 continuously on a mobile phone keypad, or pressing keys of 4, 5, 6 continuously on a remote controller keypad 4, 5, 6. In this way, the corresponding input command can be simply generated by pressing key and sliding on the keyboard, which does not require complex operation or finding the exact key for the specific input command among all keys, so the operation will become simpler.

In an embodiment, sequences predefined by the input device 400 represent adjacent keys are pressed continuously to form a preset vector graphic. For example, the preset vector graphic can be at least one of a horizontal straight line, a vertical straight line, a hook shape, a crisscross, a circular shape, or a character shape. The preset vector graphic can be represented by the direct prestored sequence, or be reflected by the calculation rules mentioned above. Representing with the preset vector graphic is beneficial to understanding the operation. For example, a user only requires pressing adjacent keys on the keyboard to form a hook shape when he wants to input an “OK” command; and he only requires pressing adjacent keys on the keyboard to form a crisscross when he wants to input a “cancel” command.

In an embodiment, sequences predefined by the input device 400 represent more than two adjacent keys on a region of the keyboard being pressed at the same time. By setting this type of predefined sequence, some preset functions can be enabled when a user presses more than two adjacent keys on a region of the keyboard at the same time. For example, the user can press a plurality of keys on the keyboard by his palm to achieve the function of closing the whole program.

In an embodiment, sequences predefined by the input device 400 represent one key is pressed continuously. By setting this type of predefined sequence, some preset functions can be enabled when a user presses one key continuously. For example, the user can press S key continuously to enable the searching function.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An input method comprising the steps of:
receiving a key event sequence inputted by a keyboard;
comparing the key event sequence with prestored data, determining whether the key event sequence is a sequence predefined by the prestored data;
if the key event sequence is determined to be the sequence predefined by the prestored data, finding an input command corresponding with the key event sequence according to a mapping relationship and sending the input command to a command processing system.

2. The input method according to claim 1, wherein the step of comparing the key event sequence with prestored data, determining whether the key event sequence is a sequence predefined by the prestored data comprises:
calculating a feature value of the key event sequence, the feature value is feature information to represent a corresponding location of a single key event in the key event sequence;
comparing the feature value with a preset standard feature value set, if the feature value is in the preset standard feature value set, determining the key event sequence as the sequence predefined by the prestored data, otherwise ending current input process.

3. The input method according to claim 1 or 2, wherein the predefined sequence represents adjacent keys are pressed continuously.

4. The input method according to claim 3, wherein the predefined sequence represents adjacent keys are pressed continuously to form a preset vector graphic.

5. The input method according to claim 4, wherein the preset vector graphic can be at least one of a horizontal straight line, a vertical straight line, a hook shape, a crisscross, a circular shape, or a character shape.

6. The input method according to claim 1, wherein the predefined sequence represents at least two adjacent keys on a region of the keyboard being pressed at the same time or one key being pressed continuously.

7. An input device comprising:
a receiver module used for receiving a key event sequence inputted by a keyboard;
a memory module used for prestoring data representing a predefined sequence;
a control module used for comparing the key event sequence with the prestored data, determining whether the key event sequence is a sequence predefined by the prestored data; if the key event sequence is determined to be a sequence predefined by the prestored data, finding an input command corresponding with the key event sequence according to a mapping relationship and sending the input command to a command processing system.

8. The input device according to claim 7, wherein the control module comprising:
a calculation unit used for calculating a feature value of the key event sequence, the feature value is feature information to represent a corresponding location of a single key event in the key event sequence;
a compare unit used for comparing the feature value with a preset standard feature value set, if the feature value is in the preset standard feature value set, determining the key event sequence as the sequence predefined by the prestored data, otherwise ending current input process.

9. The input device according to claim 7 or 8, wherein the predefined sequence represents adjacent keys are pressed continuously.

10. The input device according to claim 9, wherein the predefined sequence represents adjacent keys are pressed continuously to form a preset vector graphic.

11. The input device according to claim 10, wherein the vector graphic can be at least one of a horizontal straight line, a vertical straight line, a hook shape, a crisscross, a circular shape, or a character shape.

12. The input device according to claim 7, wherein the predefined sequence represents at least two adjacent keys on a region of the keyboard being pressed at the same time or one key being pressed continuously.
